(19) United States
(12) Patent Application Publication
(10) Pub. No.: US 2018/0052683 A1
(43) Pub. Date: Feb. 22, 2018

(54) SYSTEM DESIGN SUPPORTING DEVICE, SYSTEM DESIGN SUPPORTING METHOD, AND SYSTEM DESIGN SUPPORTING PROGRAM

(71) Applicant: Mitsubishi Electric Corporation, Chiyoda-ku (JP)

(72) Inventor: Yoshinori IGUCHI, Tokyo (JP)

(73) Assignee: Mitsubishi Electric Corporation, Chiyoda-ku (JP)

(21) Appl. No.: 15/555,675

(22) PCT Filed: Mar. 26, 2015
(86) PCT No.: PCT/JP2015/059435

§ 371 Date: Sep. 5, 2017

(51) Int. Cl. G06F 9/44; G06F 21/62; G05B 19/042

(52) U.S. Cl. CPC G06F 8/71; G05B 19/0426; G06F 21/6209

(57) ABSTRACT

A system design supporting device has: a storage unit to store therein plural pieces of profile data, each of which includes project data information in which a configuration of project data to be transferred to a control apparatus is described, and network identification information in which a communication path is described; a system-configuration-diagram creation unit to create a system configuration diagram; a selection receiving unit to receive a selection of the control apparatus; and a backup unit to create backup project data on the basis of the project data information within the profile data that corresponds to the selected control apparatus.

### FIELD

The present invention relates to a system design supporting device, a system design supporting method, and a system design supporting program, which support design of a factory automation (FA) system.

### BACKGROUND

A FA system that operates an industrial machine is configured by combining a number of control apparatuses. For example, the control apparatuses are realized by a sensor, an input/output (I/O) device, a temperature adjustment device, a robot, a servo device, and a vision sensor. A user only needs to create parameters for the sensor, the I/O device, and the temperature adjustment device, without the need for creating their respective programs. The user creates project data for the robot, the servo device, and the vision sensor, which includes a program, and parameters to be referenced in the program.

Conventional profile data to be used in the FA system is a file in which device information and a simple parameter-setting procedure are described, and in the file information involved in control is not described. Therefore, the profile data has not been able to be utilized for more complex control apparatuses such as those which use project data, and has been only intended for the I/O device or analog devices.

Project data is created by using a programming tool executed by a personal computer, and is then transferred to a control apparatus. Therefore, the project data is present in the control apparatus, while being present in a storage device of the personal computer. However, the project data is sometimes finely adjusted, that is, altered on the control apparatus, while operating an industrial machine. After the project data has been altered on the control apparatus, if this control apparatus breaks down, or is replaced, then the altered project data is lost. For this reason, it is necessary to back up the project data in the control apparatus to the personal computer.

Conventionally, project data in a control apparatus has been backed up by using a system-design supporting tool program executed by a personal computer. The system-design supporting tool program has backed up project data from the control apparatus to the personal computer through middleware provided by a manufacturer of the control apparatus. Therefore, it has been difficult for the system-design supporting tool program to back up project data in a control apparatus whose middleware is not provided by the manufacturer.

As a related technique, Patent Literature 1 describes a system including a communication control device provided between a plurality of instruction devices and a plurality of PLCs (FIG. 3). In accordance with communication information and protocol information, a communication program 30 within the communication control device 20 edits a read command transmitted from the instruction device into a read command corresponding to a communication destination PLC, and transmits this resultant read command to the PLC. The PLC having received the read command transmits a response and the read data to the communication program 30. Upon receiving the response and the read data from the PLC, the communication program 30 analyzes their details based on the communication information and protocol information, and thereafter edits a tag file 38. Next, the communication program 30 transmits a communication result to a functional application 42 within the instruction device. The functional application 42 having received the communication result acquires the read data from the tag file 38 (Paragraphs 0040 and 0041).

Patent Literature 2 describes a connected sensor system 1 including a network unit 10 provided between a higher-level control device and a plurality of sensor units (FIG. 1). A sensor setting-information memory 14c in the network unit 10 is a memory that stores therein setting information for each sensor unit connected to the network unit 10. Various types of setting information stored in the sensor setting-information memory 14c are readable and writable through message communication from the higher-level control device 14 (Paragraph 0065).

### CITATION LIST

### Patent Literatures

Patent Literature 1: Japanese Patent Application Laid-open No. 2008-250473

Patent Literature 2: Japanese Patent Application Laid-open No. 2011-28525

### SUMMARY

### Technical Problem

The present invention has been achieved in view of the above circumstances, and an object of the present invention is to provide a system design supporting device that is capable of backing up project data of a control apparatus without the need for middleware.

### Solution to Problem

The present invention includes a storage unit that stores therein plural pieces of profile data, which correspond respectively to plural control apparatuses, and each include project data information having a configuration of project data to be transferred to the control apparatus described therein, network identification information having a network of a communication path used to communicate with the control apparatus described therein, and communication protocol information having a configuration of a communication packet to be transmitted to and received from the control apparatus and a communication procedure described therein.

The present invention provides a system design supporting device comprising: a storage unit to store therein plural pieces of profile data, each of which corresponds to each of plural control apparatuses, and includes project data information in which a configuration of project data to be transferred to the control apparatus is described, and network identification information in which a communication path used to communicate with the control apparatus is described; a system-configuration-diagram creation unit to create a system configuration diagram representing a connection configuration of the control apparatuses on the basis of the network identification information within the plural pieces of profile data; a selection receiving unit to display the system configuration diagram, and to receive a selection of the control apparatus on the system configuration diagram; and a backup unit to create backup project data on the basis of the project data information within the profile data that corresponds to the selected control apparatus.

### Advantageous Effects of Invention

The system design supporting device of the present invention has an advantageous effect that it is possible to back up project data of a control apparatus without the need for middleware.

### BRIEF DESCRIPTION OF DRAWINGS

FIG. 1 is a diagram illustrating a configuration of a system using a system design supporting device according to a first embodiment.

FIG. 2 is a diagram illustrating a hardware configuration of the system design supporting device according to the first embodiment.

FIG. 3 is a functional block diagram of the system design supporting device according to the first embodiment.

FIG. 4 is a diagram illustrating first profile data according to the first embodiment.

FIG. 5 is an image diagram of the system using the system design supporting device according to the first embodiment.

FIG. 6 is a flowchart illustrating a system-configuration-diagram creating process according to the first embodiment.

FIG. 7 is a diagram illustrating an example of a system configuration diagram according to the first embodiment.

FIG. 8 is a flowchart illustrating a selection receiving process according to the first embodiment.

FIG. 9 is a flowchart illustrating a main file-restoring process according to the first embodiment.

FIG. 10 is a flowchart illustrating a project-data confirmation process subroutine according to the first embodiment.

FIG. 11 is a diagram illustrating an example of a communication packet according to the first embodiment.

FIG. 12 is a diagram illustrating a file configuration of backup project data according to the first embodiment.

FIG. 13 is a diagram illustrating a file configuration of backup project data according to the first embodiment.

FIG. 14 is a flowchart illustrating a programming-tool confirmation process subroutine according to the first embodiment.

### DESCRIPTION OF EMBODIMENTS

A system design supporting device, a system design supporting method, and a system design supporting program according to an embodiment of the present invention will be described in detail below with reference to the drawings. The present invention is not limited to the embodiment.

### First Embodiment

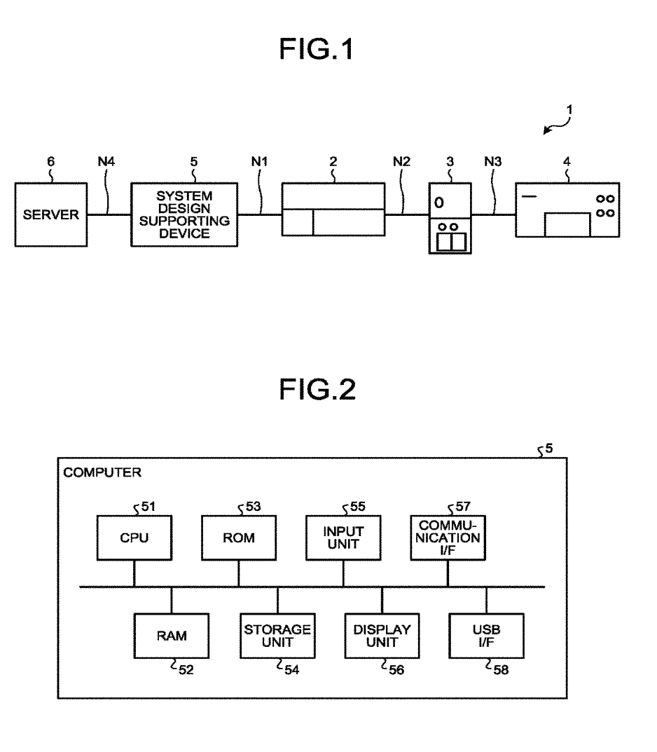

FIG. 1 is a diagram illustrating a configuration of a system using a system design supporting device according to a first embodiment. A system 1 includes a first control apparatus 2, a second control apparatus 3, a third control apparatus 4, and a system design supporting device 5. The first control apparatus 2, the second control apparatus 3, and the third control apparatus 4 control an industrial machine. For example, the first control apparatus 2, the second control apparatus 3, and the third control apparatus 4 are realized by a robot, a servo device, and a vision sensor.

The system design supporting device 5 is connected to the first control apparatus 2 through a network N1. The network N1 is realized by a USB (Universal Serial Bus), for example.

The first control apparatus 2 is connected to the second control apparatus 3 through a network N2. The network N2 is realized by Ethernet (registered trademark), for example.

The second control apparatus 3 is connected to the third control apparatus 4 through a network N3. For example, the network N3 is realized by a FA system network.

The system design supporting device 5 is connected to a server 6 through a network N4. As an example of the network N4, a LAN (Local Area Network) or the Internet is used.

In the first embodiment, there is illustrated the case in which the first control apparatus 2, the second control apparatus 3, the third control apparatus 4, and the system design supporting device 5 are connected in series, as an example. It is also possible that the first control apparatus 2, the second control apparatus 3, the third control apparatus 4, and the system design supporting device 5 are connected in a tree structure.

FIG. 2 is a diagram illustrating a hardware configuration of the system design supporting device according to the first embodiment. The system design supporting device 5 according to the first embodiment is a computer. The system design supporting device 5 includes a CPU (Central Processing Unit) 51, a RAM (Random Access Memory) 52, a ROM (Read Only Memory) 53, a storage unit 54, an input unit 55, a display unit 56, a communication interface 57, and a USB interface 58.

While using the RAM 52 as a workspace, the CPU 51 executes a program stored in the ROM 53 and the storage unit 54. For example, the program stored in the ROM 53 is realized by a BIOS (Basic Input/Output System) or a UEFI (Unified Extensible Firmware Interface). As an example of the program stored in the storage unit 54, an operating system program, a programming-tool program, or a backup processing program is used. For example, the storage unit 54 is realized by a SSD (Solid State Drive) or a HDD (Hard Disk Drive).

The input unit 55 receives an operational input from a user. The input unit 55 is, for example, realized by a keyboard or a mouse. The display unit 56 displays characters and images. For example, the display unit 56 is realized by a liquid-crystal display device. The communication interface 57 communicates with the server 6 through the network N4. The USB interface 58 communicates with the control apparatus 2 through the network N1.

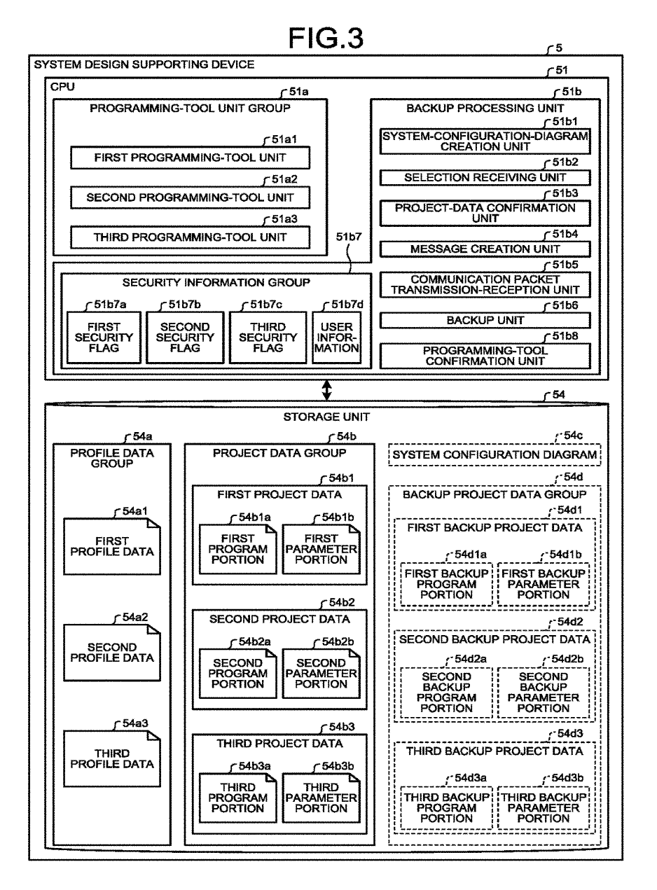

FIG. 3 is a functional block diagram of the system design supporting device according to the first embodiment. The CPU 51 executes a group of programming-tool programs including a first programming-tool program, a second programming-tool program, and a third programming-tool program, which are stored in the storage unit 54. With this execution, a programming-tool unit group 51a is implemented, which includes a first programming-tool unit 51a1 that creates first project data 54b1 to be transferred to the first control apparatus 2, a second programming-tool unit 51a2 that creates second project data 54b2 to be transferred to the second control apparatus 3, and a third programming-tool unit 51a3 that creates third project data 54b3 to be transferred to the third control apparatus 4.

It is also possible that a plurality of processing circuits are coordinated with each other to implement a function of the programming-tool unit group 51a.

The storage unit 54 stores therein a profile data group 54a including first profile data 54a1 to be referenced by the first programming-tool unit 51a1 when the first programming-tool unit 51a1 creates the first project data 54b1, second profile data 54a2 to be referenced by the second programming-tool unit 51a2 when the second programming-tool unit 51a2 creates the second project data 54b2, and third profile data 54a3 to be referenced by the third programming-tool unit 51a3 when the third programming-tool unit 51a3 creates the third project data 54b3.

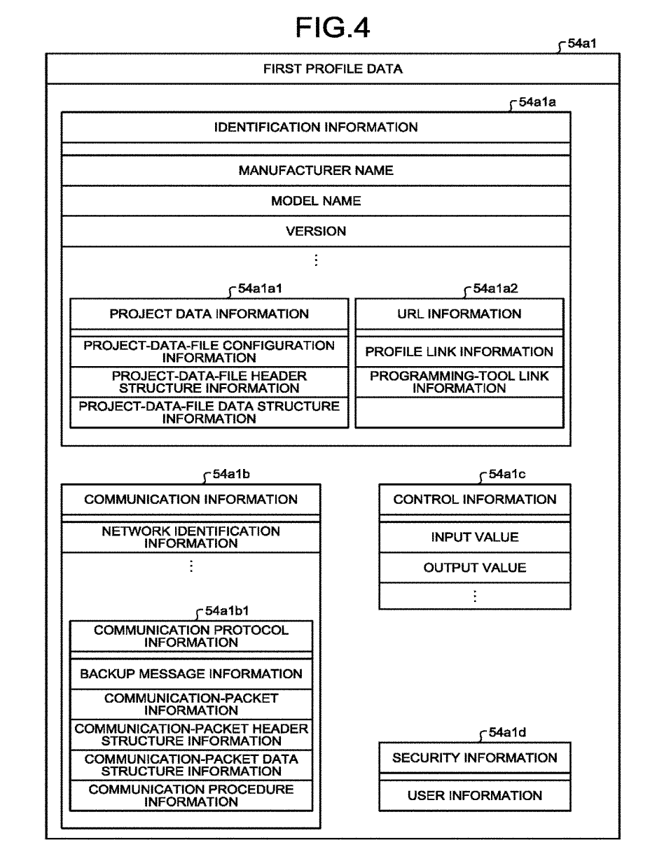

FIG. 4 is a diagram illustrating the first profile data according to the first embodiment. The first profile data 54a1 includes identification information 54a1a, communication information 54a1b, control information 54a1c, and security information 54a1d.

The second profile data 54a2 and the third profile data 54a3 also have the same data configuration as the first profile data 54a1. Therefore, the first profile data 54a1 is only described as a representative example.

The identification information 54a1a includes an item of “manufacturer name”, an item of “model name”, and an item of “version”. In the item of “manufacturer name”, a name of a manufacturer of the first control apparatus 2 is described. In the item of “model name”, a model name of the first control apparatus 2 is described. In the item of “version”, a firmware version of the first control apparatus 2 is described.

The identification information 54a1a further includes project data information 54a1a1 and URL (Uniform Resource Locator) information 54a1a2. The project data information 54a1a1 has a configuration of the first project data 54b1 to be transferred to the first control apparatus 2 described therein. The URL information 54a1a2 is file location information.

The project data information 54a1a1 includes an item of “project-data-file configuration information”, an item of “project-data-file header structure information”, and an item of “project-data-file data structure information”.

In the item of “project-data-file configuration information”, a hierarchical structure and a file name of one or more files that constitute the first project data 54b1 are described.

In the item of “project-data-file header structure information”, a header structure of one or more files that constitute the first project data 54b1 is described.

In the item of “project-data-file data structure information”, a data structure of one or more files that constitute the first project data 54b1 is described.

The URL information 54a1a2 includes an item of “profile link information” and an item of “programming-tool link information”.

In the item of “profile link information”, a URL is described, which indicates the location of the latest version or the previous version of the first profile data 54a1 within the server 6.

In the item of “programming-tool link information”, a URL is described, which indicates the location of the latest version or the previous version of the first programming-tool program within the server 6.

The communication information 54a1b includes an item of “network identification information” in which a network of the communication path for communicating with the first control apparatus 2 is described. In the item of “network identification information”, an identifier is described, which identifies a network of the communication path extending from the system design supporting device 5 to the first control apparatus 2. In the first embodiment, the system design supporting device 5 is connected directly to the first control apparatus 2 through the network N1. Therefore, in the item of “network identification information”, a network name or a network ID of the network N1 is described.

Now an item of “network identification information” in the second profile data 54a2 is described. In the first embodiment, the system design supporting device 5 is connected indirectly to the second control apparatus 3 through the network N1 and the network N2. Therefore, in the item of “network identification information” in the second profile data 54a2, a network name or a network ID of the network N1, as well as a network name or a network ID of the network N2, are described.

Now an item of “network identification information” in the third profile data 54a3 is described. In the first embodiment, the system design supporting device 5 is connected indirectly to the third control apparatus 4 through the network N1, the network N2, and the network N3. Therefore, in the item of “network identification information” in the third profile data 54a3, there are described a network name or an network ID of the network N1, and a network name or a network ID of the network N2 as well as a network name or a network ID of the network N3.

Descriptions are focused again on the first profile data 54a1. The communication information 54a1b further includes communication protocol information 54a1b1 in which a configuration of a communication packet to be transmitted to or received from the first control apparatus 2, and a communication procedure therefor are described.

The communication protocol information 54a1b1 includes an item of “backup message information”, an item of “communication-packet information”, an item of “communication-packet header structure information”, an item of “communication-packet data structure information”, and an item of “communication procedure information”.

In the item of “backup message information”, the details in a message are described, which requests the first control apparatus 2 to transmit the first project data 54b1 when backup of the first control apparatus 2 is performed.

In the item of “communication-packet information”, one or more types of packets to be transmitted and received between the system design supporting device 5 and the first control apparatus 2 are described.

In the item of “communication-packet header structure information”, a header structure of a packet to be transmitted and received between the system design supporting device 5 and the first control apparatus 2 is described.

In the item of “communication-packet data structure information”, a data structure of a packet to be transmitted and received between the system design supporting device 5 and the first control apparatus 2 is described.

In the item of “communication procedure information”, a procedure is described, which is used to transmit and receive a packet between the system design supporting device 5 and the first control apparatus 2 when the system design supporting device 5 and the first control apparatus 2 communicate with each other.

The control information 54a1c includes an item of “input value” and an item of “output value”. In the item of “input value”, the location to which a value is to be inputted within a first parameter portion 54b1b, or the value to be inputted is described. In the item of “output value”, the location to which a value is to be outputted within the first parameter portion 54b1b is described.

The security information 54a1d includes an item of “user information”. In the item of “user information”, a user name or a user ID of a user who has created the first profile data 54a1 is described.

The first programming-tool unit 51a1 references the first profile data 54a1, creates the first project data 54b1 on the basis of the user's input, and then transfers the first project data 54b1 to the first control apparatus 2.

The first project data 54b1 includes a first program portion 54b1a to be executed by the first control apparatus 2, and the first parameter portion 54b1b to be referenced from the first program portion 54b1a. The first program portion 54b1a is formed of one or more files. The first parameter portion 54b1b is formed of one or more files.

It is possible that the first project data 54b1 further includes a device memory portion in which a memory map of the first control apparatus 2 is described, or further includes a connection information portion in which a connection relationship between the first control apparatus 2 and the industrial machine is described.

The second programming-tool unit 51a2 references the second profile data 54a2, creates the second project data 54b2 on the basis of the user's input, and then transfers the second project data 54b2 to the second control apparatus 3.

The second project data 54b2 includes a second program portion 54b2a to be executed by the second control apparatus 3, and a second parameter portion 54b2b to be referenced from the second program portion 54b2a. The second program portion 54b2a is formed of one or more files. The second parameter portion 54b2b is formed of one or more files.

It is possible that the second project data 54b2 further includes a device memory portion in which a memory map of the second control apparatus 3 is described, or further includes a connection information portion in which a connection relationship between the second control apparatus 3 and the industrial machine is described.

The third programming-tool unit 51a3 references the third profile data 54a3, creates the third project data 54b3 on the basis of the user's input, and then transfers the third project data 54b3 to the third control apparatus 4.

The third project data 54b3 includes a third program portion 54b3a to be executed by the third control apparatus 4, and a third parameter portion 54b3b to be referenced by the third program portion 54b3a. The third program portion 54b3a is formed of one or more files. The third parameter portion 54b3b is formed of one or more files.

It is possible that the third project data 54b3 further includes a device memory portion in which a memory map of the third control apparatus 4 is described, or further includes a connection information portion in which a connection relationship between the third control apparatus 4 and the industrial machine is described.

The first project data 54b1, the second project data 54b2, and the third project data 54b3 constitute a project data group 54.

The CPU 51 executes the backup processing program stored in the storage unit 54. With this execution, a backup processing unit 51b is implemented. The backup processing unit 51b backs up the first project data 54b1 in the first control apparatus 2 to create first backup project data 54d1 within the storage unit 54, backs up the second project data 54b2 in the second control apparatus 3 to create second backup project data 54d2 within the storage unit 54, or backs up the third project data 54b3 in the third control apparatus 4 to create third backup project data 54d3 within the storage unit 54.

It is also possible that a number of processing circuits are connected to each other to implement a function of the backup processing unit 51b.

The backup processing unit 51b includes a system-configuration-diagram creation unit 51b1, and a selection receiving unit 51b2. The system-configuration-diagram creation unit 51b1 creates a system configuration diagram 54c within the storage unit 54, the diagram representing a connection configuration of the first control apparatus 2, the second control apparatus 3, and the third control apparatus 4, on the basis of the network identification information within the profile data group 54a. The selection receiving unit 51b2 caused the display unit 56 to display the system configuration diagram 54c, and receives a user's selection of the first control apparatus 2, the second control apparatus 3, or the third control apparatus 4 on the system configuration diagram 54c.

In addition, the backup processing unit 51b further includes a project-data confirmation unit 51b3. The project-data confirmation unit 51b3 checks the details in the item of “version” within the profile data corresponding to a selected control apparatus, against the version of the selected control apparatus. When the details in the item of “version” within the profile data corresponding to the selected control apparatus do not correspond with the version of the selected control apparatus, the project-data confirmation unit 51b3 acquires the profile data having a version corresponding with the version of the selected control apparatus, from the location represented by the details in the item of “profile link information” within the profile data.

The backup processing unit 51b further includes a message creation unit 51b4, a communication packet transmission-reception unit 51b5, and a backup unit 51b6. On the basis of the communication protocol information within the profile data corresponding to a control apparatus which is selected from among the first control apparatus 2, the second control apparatus 3, and the third control apparatus 4, the message creation unit 51b4 creates a communication packet of a message that requests the selected control apparatus to transmit the project data. On the basis of the communication protocol information within the profile data corresponding to the selected control apparatus, the communication packet transmission-reception unit 51b5 transmits a communication packet of the message to the selected control apparatus, and also receives a communication packet of the project data from the selected control apparatus. On the basis of the communication protocol information and the project data information within the profile data corresponding to the selected control apparatus, the backup unit 51b6 restores the communication packet received from the selected control apparatus to the original file, and creates the first backup project data 54d1, the second backup project data 54d2, or the third backup project data 54d3.

The first backup project data 54d1 includes a first backup program portion 54d1a and a first backup parameter portion 54d1b.

The second backup project data 54d2 includes a second backup program portion 54d2a and a second backup parameter portion 54d2b.

The third backup project data 54d3 includes a third backup program portion 54d3a and a third backup parameter portion 54d3b.

The first backup project data 54d1, the second backup project data 54d2, and the third backup project data 54d3 constitute a backup project data group 54d.

The backup processing unit 51b further includes a security information group 51b7. The security information group 51b7 includes a first security flag 51b7a that indicates whether to encrypt the first backup parameter portion 54d1b within the first backup project data 54d1, a second security flag 51b7b that indicates whether to encrypt the second backup parameter portion 54d2b within the second backup project data 54d2, a third security flag 51b7c that indicates whether to encrypt the third backup parameter portion 54d3b within the third backup project data 54d3, and user information 51b7d that is a user name or a user ID of a user who is permitted to create the first backup project data 54d1, the second backup project data 54d2, and the third backup project data 54d3. The user information 51b7d corresponds to second user information of the present invention.

When the first security flag 51b7a is set to “1”, it indicates that the first backup parameter portion 54d1b is to be encrypted. When the first security flag 51b7a is set to “0”, it indicates that the first backup parameter portion 54d1b is not to be encrypted. When the second security flag 51b7b is set to “1”, it indicates that the second backup parameter portion 54d2b is to be encrypted. When the second security flag 51b7b is set to “0”, it indicates that the second backup parameter portion 54d2b is not to be encrypted. When the third security flag 51b7c is set to “1”, it indicates that the third backup parameter portion 54d3b is to be encrypted. When the third security flag 51b7c is set to “0”, it indicates that the third backup parameter portion 54d3b is not to be encrypted.

It is also possible that when the first security flag 51b7a is set to “1”, it indicates that the first backup project data 54d1 is to be encrypted. It is also possible that when the second security flag 51b7b is set to “1”, it indicates that the second backup project data 54d2 is to be encrypted. It is also possible that when the third security flag 51b7c is set to “1”, it indicates that the third backup project data 54d3 is to be encrypted.

The backup processing unit 51b further includes a programming-tool confirmation unit 51b8. The programming-tool confirmation unit 51b8 checks the version of the first backup project data 54d1, the second backup project data 54d2, or the third backup project data 54d3, against the version of the first programming-tool program, the second programming-tool program, or the third programming-tool program. When the version of the first backup project data 54d1, the second backup project data 54d2, or the third backup project data 54d3 does not correspond with the version of the first programming-tool program, the second programming-tool program, or the third programming-tool program, then the programming-tool confirmation unit 51b8 acquires a first programming-tool program, a second programming-tool program, or a third programming-tool program, which corresponds with the version of the first backup project data 54d1, the second backup project data 54d2, or the third backup project data 54d3, from the location shown by the details in the item of “programming-tool link information” within the first profile data 54a1, the second profile data 54a2, or the third profile data 54a3.

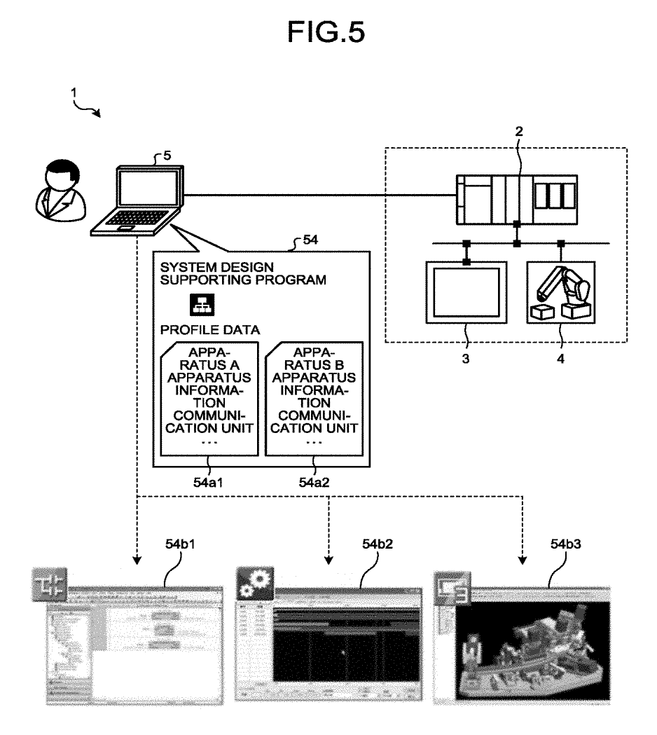

FIG. 5 is an image diagram of a system using the system design supporting device according to the first embodiment. By executing the first programming-tool program stored in the storage unit 54, the system design supporting device 5 references the first profile data 54a1, creates the first project data 54b1 on the basis of the user's input, and then transfers the first project data 54b1 to the first control apparatus 2.

By executing the second programming-tool program stored in the storage unit 54, the system design supporting device 5 references the second profile data 54a2, creates the second project data 54b2 on the basis of the user's input, and then transfers the second project data 54b2 to the second control apparatus 3.

By executing the third programming-tool program stored in the storage unit 54, the system design supporting device 5 references the third profile data 54a3, creates the third project data 54b3 on the basis of the user's input, and then transfers the third project data 54b3 to the third control apparatus 4.

In the manner as described above, by executing different programming-tool programs, the system design supporting device 5 can create different types of project data for the control apparatuses, respectively.

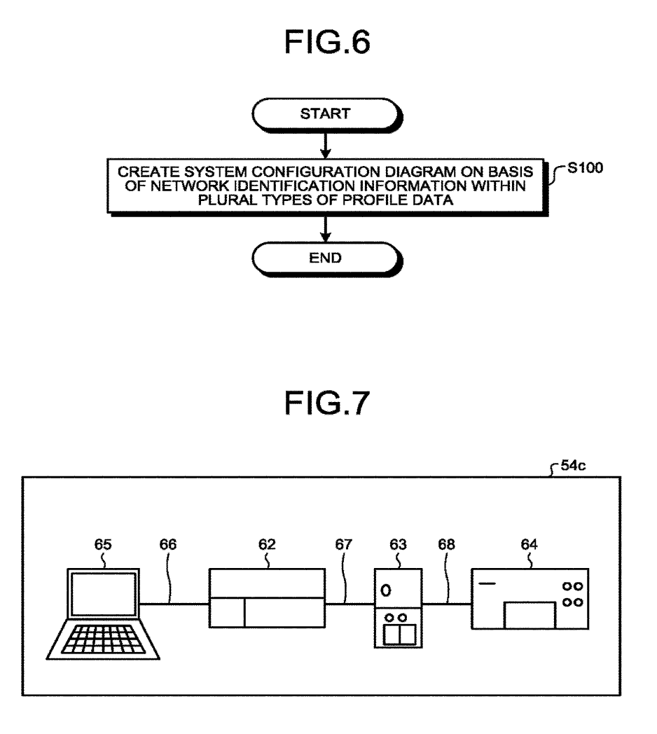

FIG. 6 is a flowchart illustrating a system-configuration-diagram creating process according to the first embodiment. At Step S100, the system-configuration-diagram creation unit 51b1 creates the system configuration diagram 54c within the storage unit 54, the diagram 540 representing a connection configuration of the first control apparatus 2, the second control apparatus 3, and the third control apparatus 4, on the basis of the network identification information within the first profile data 54a1, the second profile data 54a2, and the third profile data 54a3.

By referencing the network identification information within the first profile data 54a1, the system-configuration-diagram creation unit 51b1 can obtain the information that the system design supporting device 5 and the first control apparatus 2 are directly connected through the network N1. By referencing the network identification information within the second profile data 54a2, the system-configuration-diagram creation unit 51b1 can obtain the information that the system design supporting device 5 and the second control apparatus 3 are indirectly connected through the network N1 and the network N2. By referencing the network identification information within the third profile data 54a3, the system-configuration-diagram creation unit 51b1 can obtain the information that the system design supporting device 5 and the third control apparatus 4 are indirectly connected through the network N1, the network N2, and the network N3.

FIG. 7 is a diagram illustrating an example of a system configuration diagram according to the first embodiment. The system configuration diagram 54c includes an image 62 corresponding to the first control apparatus 2, an image 63 corresponding to the second control apparatus 3, an image 64 corresponding to the third control apparatus 4, an image 65 corresponding to the system design supporting device 5, an image 66 corresponding to the network N1, an image 67 corresponding to the network N2, and an image 68 corresponding to the network N3.

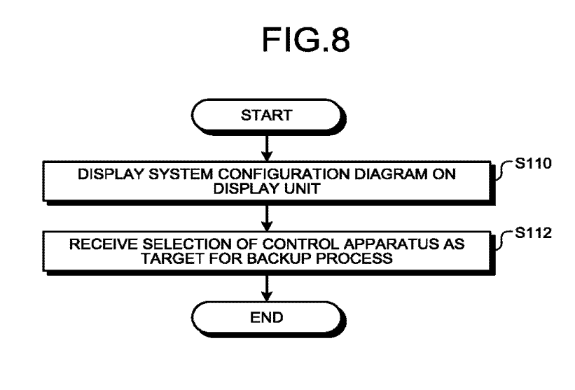

FIG. 8 is a flowchart illustrating a selection receiving process according to the first embodiment. At Step S110, the selection receiving unit 51b2 displays the system configuration diagram 54c on the display unit 56. Next, at Step S112, the selection receiving unit 51b2 receives a selection of one or more control apparatuses as a target for the backup process. A user selects the image 62, 63, or 64 on the system configuration diagram 54c, and can thereby select one or more control apparatuses as a target for the backup process. For example, the image 62, 63, or 64 is selected by clicking a mouse on the corresponding image 62, 63, or 64.

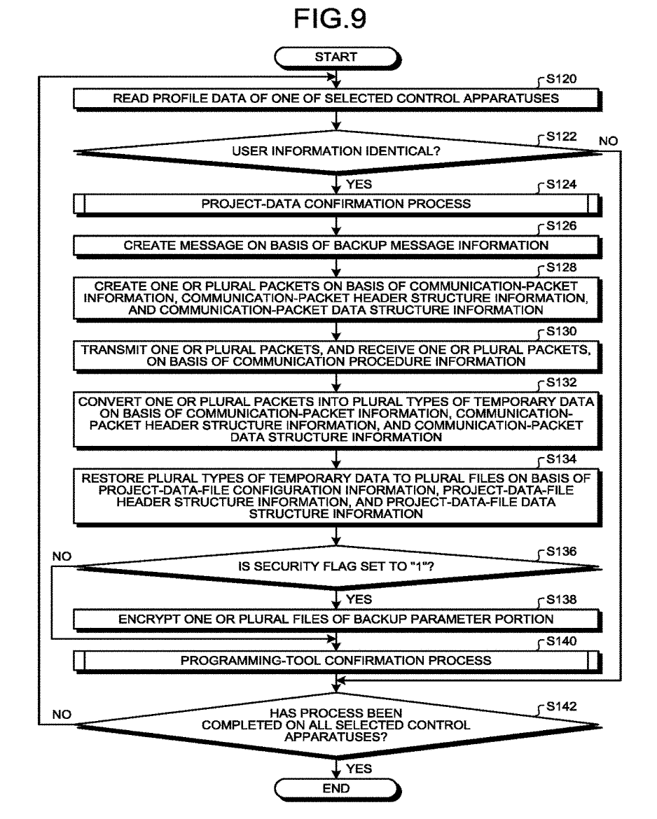

FIG. 9 is a flowchart illustrating a main file-restoring process according to the first embodiment. At Step S120, the selection receiving unit 51b2 reads the profile data of one of the selected control apparatuses.

Next, at Step S122, the project-data confirmation unit 51b3 determines whether the details in the item of “user information” of the security information 54a1d in the read profile data match with the details of the user information 51b7d within the security information group 51b7, that is, whether a user is permitted to perform the backup process.

When the project-data confirmation unit 51b3 determines that the details in the item of “user information” of the security information 54a1d in the read profile data match with the details of the user information 51b7d within the security information group 51b7, that is, that a user is permitted to perform the backup process (YES), then the unit 51b3 advances the process to Step S124 to continue the backup process.

In contrast, when the project-data confirmation unit 51b3 determines that the details in the item of “user information” of the security information 54a1d in the read profile data do not match with the details of the user information 51b7d within the security information group 51b7, that is, that a user is not permitted to perform the backup process (NO), then the unit 51b3 advances the process to Step S142.

Due to this operation, the system design supporting device 5 can permit only an authorized user to back up the project data, while prohibiting an unauthorized user from backing up the data. The first backup project data 54d1, the second backup project data 54d2, and the third backup project data 54d3 are important technical assets which include know-how to drive the industrial machine. The system design supporting device 5 can prevent improper use of the technical assets by prohibiting an unauthorized user from backing up the data.

Next, at Step S124, the project-data confirmation unit 51b3 executes the project-data confirmation process subroutine.

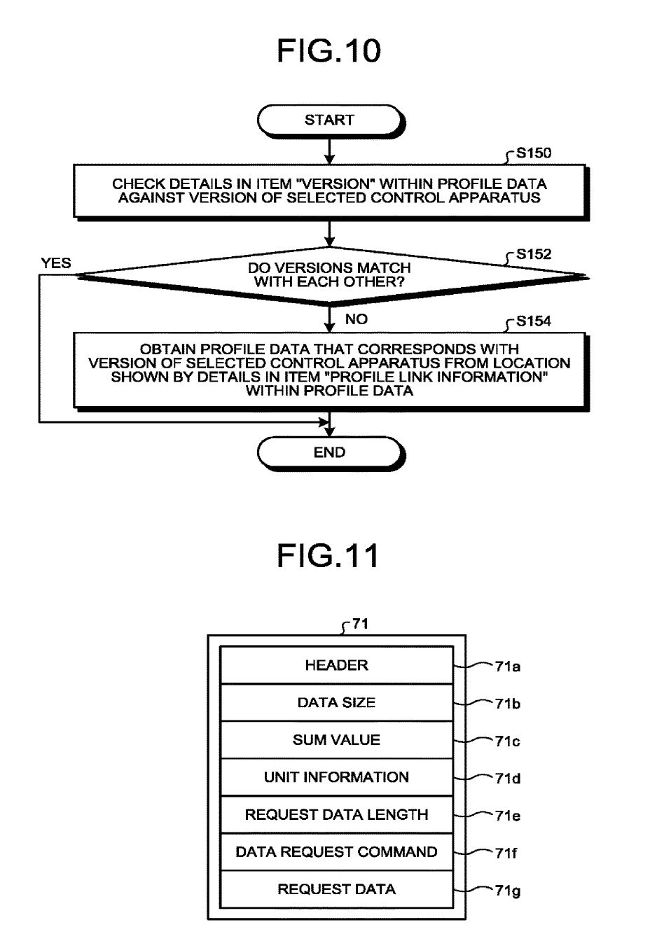

FIG. 10 is a flowchart illustrating a project-data confirmation process subroutine according to the first embodiment. At Step S150, the project-data confirmation unit 51b3 checks the details in the item of “version” within the read profile data against the version of a selected control apparatus. It is also possible that the version of a selected control apparatus is stored in advance in the storage unit 54, or is acquired at Step S150 by transmitting a version-requesting message to the selected control apparatus.

Next, at Step S152, the project-data confirmation unit 51b3 determines whether or not the details in the item of “version” within the read profile data match with the version of the selected control apparatus.

When the project-data confirmation unit 51b3 determines that the details in the item of “version” within the read profile data do not match with the version of the selected control apparatus (NO), the unit 51b3 advances the process to Step S154. When the project-data confirmation unit 51b3 determines that the details and the version match with each other (YES), the process is ended.

At Step S154, the project-data confirmation unit 51b3 acquires the profile data which corresponds with the version of the selected control apparatus, from the location within the server 6 which is shown by the details in the item of “profile link information” within the read profile data, and stores the acquired profile data in the profile data group 54a. In a case where there are two or more types of profile data corresponding with the version of a selected control apparatus within the server 6, the project-data confirmation unit 51b3 acquires the latest profile data.

Due to this operation, when the details in the item of “version” within the read profile data do not match with the version of a selected control apparatus, the system design supporting device 5 can acquire the latest profile data that corresponds with the version of the selected control apparatus. When the details in the item of “version” within the read profile data do not match with the version of a selected control apparatus, there is a possibility that the data has not been properly backed up. The system design supporting device 5 acquires the latest profile data that corresponds with the version of a selected control apparatus, thereby making it possible to perform the backup process more properly on the basis of the latest profile data corresponding with the selected control apparatus.

Referring back to FIG. 9, at Step S126, the message creation unit 51b4 creates a message that requests a selected control apparatus to transmit the project data, on the basis of the details in the item of “backup message information” within the communication protocol information 54a1b1 in the read profile data.

Next, at Step S128, the communication packet transmission-reception unit 51b5 creates one or more packets from the message that requests the selected control apparatus to transmit the project data, on the basis of the details in the item of “communication-packet information”, the item of “communication-packet header structure information”, and the item of “communication-packet data structure information” within the communication protocol information 54a1b1 in the read profile data.

FIG. 11 is a diagram illustrating an example of a communication packet according to the first embodiment. A communication packet 71 includes a header 71a that includes information related to a whole of the communication packet 71, a data size 71b that indicates the size of the data included in the communication packet 71, a sum value 71c that is a check sum of the entire communication packet 71, unit information 71d that is information for identifying a control apparatus being a communication destination, a request data length 71e that indicates the length of the data to be requested, a data request command 71f that is a command for requesting a destination control apparatus to transmit data, and request data 71g that indicates the data to be requested.

Referring back to FIG. 9, at Step S130, the communication packet transmission-reception unit 51b5 transmits one or more communication packets to a selected control apparatus, and also receives one or more communication packets of the project data from the selected control apparatus, on the basis of the details in the item of “communication procedure information” within the communication protocol information 54a1b1 in the read profile data.

Next, at Step S132, the backup unit 51b6 converts one or more communication packets received from the selected control apparatus into a plurality of pieces of temporary data, on the basis of the details in the item of “communication-packet information”, the item of “communication-packet header structure information”, and the item of “communication-packet data structure information” within the communication protocol information 54a1b1 in the read profile data.

Next, at Step S134, the backup unit 51b6 restores the plural temporary data pieces to a plurality of original files, that is, backup project data, on the basis of the details in the item of “project-data-file configuration information”, the item of “project-data-file header structure information”, and the item of “project-data-file data structure information” within the project data information 54a1a1 in the read profile data.

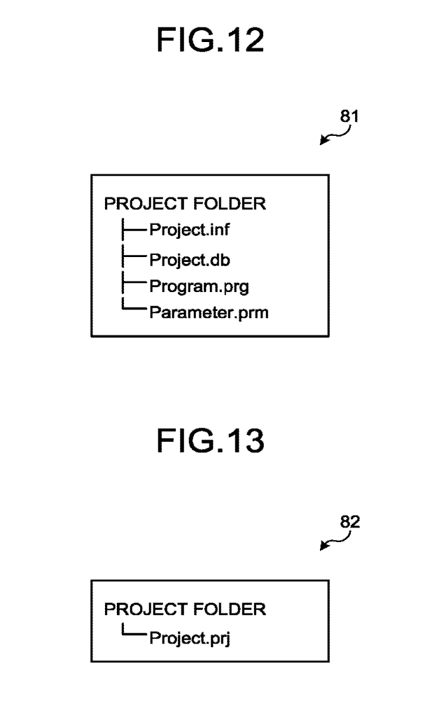

FIGS. 12 and 13 are diagrams illustrating file configurations of backup project data according to the first embodiment. A file configuration 81 illustrated in FIG. 12 shows the file configuration of the first backup project data 54d1. A file configuration 81 illustrated in FIG. 13 shows the file configuration of the third backup project data 54d3.

As illustrated in FIG. 12, the first backup project data 54d1 includes four files under control of a project folder, which are “Project.inf”, “Project.db”, “Program.prg”, and “Parameter.prm”.

As illustrated in FIG. 13, the third backup project data 54d3 includes one file “Project.prj” under control of a project folder.

Referring back to FIG. 9, at Step S136, the backup unit 51b6 determines whether or not a security flag that corresponds to a selected control apparatus from among the first security flag 51b7a, the second security flag 51b7b, and the third security flag 51b7c, is “1”. When the backup unit 51b6 determines that the security flag corresponding to a selected control apparatus from among the first security flag 51b7a, the second security flag 51b7b, and the third security flag 51b7c, is “1” (YES), the unit 51b6 advances the process to Step S138. When the backup unit 51b6 determines that the security flag is not “1” (NO), the unit 51b6 advances the process to Step S140.

At Step S138, the backup unit 51b6 encrypts one or more files constituting the backup parameter portion among the restored files in conformity to a predetermined encryption system.

It is also possible that the backup unit 51b6 encrypts one or more files constituting the entire backup project data in conformity to a predetermined encryption system.

Due to this operation, when the first security flag 51b7a, the second security flag 51b7b, or the third security flag 51b7c is set to “1”, the system design supporting device 5 can encrypt the first backup parameter portion 54d1b, the second backup parameter portion 54d2b, or the third backup parameter portion 54d3b. The first backup parameter portion 54d1b, the second backup parameter portion 54d2b, and the third backup parameter portion 54d3b are important technical assets which include know-how to drive the industrial machine. When the first security flag 51b7a, the second security flag 51b7b, or the third security flag 51b7c is set to “1”, the system design supporting device 5 encrypts the first backup parameter portion 54d1b, the second backup parameter portion 54d2b, or the third backup parameter portion 54d3b, thereby making it possible to prevent the improper use of the technical assets.

At Step S140, the programming-tool confirmation unit 51b8 executes the programming-tool confirmation process subroutine.

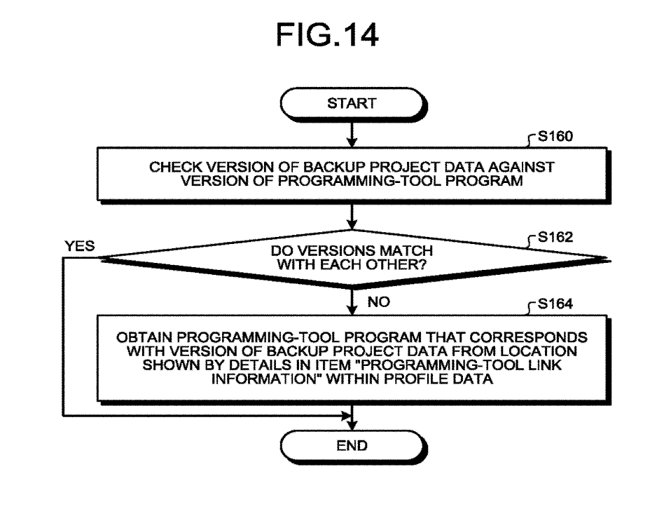

FIG. 14 is a flowchart illustrating the programming-tool confirmation process subroutine according to the first embodiment. At Step S160, the programming-tool confirmation unit 51b8 checks the version within the restored backup project data against the version of the programming-tool program.

Versions of the first programming-tool program, the second programming-tool program, and the third programming-tool program which have been used to create the backup project data are described in the first backup project data 54d1, the second backup project data 54d2, and the third backup project data 54d3, respectively.

Next, at Step S162, the programming-tool confirmation unit 51b8 determines whether or not the version within the restored backup project data matches with the version of the programming-tool program.

When the programming-tool confirmation unit 51b8 determines that the version within the restored backup project data does not match with the version of the programming-tool program (NO), the unit 51b8 advances the process to Step S164. When the programming-tool confirmation unit 51b8 determines that the versions match with each other (YES), the process is ended.

At Step S164, the programming-tool confirmation unit 51b8 acquires the programming-tool program which corresponds with the version of the restored backup project data, from the location within the server 6, which is shown by the details in the item of “programming-tool link information” within the read profile data, and then stores the acquired programming-tool program in the storage unit 54. In a case where there are a plurality of programming-tool programs within the server 6, which correspond with the version of the restored backup project data, the programming-tool confirmation unit 51b8 acquires the latest profile data.

Due to this operation, when the version within the restored backup project data does not match with the version of the programming-tool program, the system design supporting device 5 can acquire the latest programming-tool program that corresponds with the version of the restored backup project data. When the version within the restored backup project data does not match with the version of the programming-tool program, there is a possibility that the backup project data cannot be properly browsed or edited. The system design supporting device 5 obtains the latest programming-tool program that corresponds with the version of the restored backup project data, thereby making it possible to properly browse or edit the backup project data.

Referring back to FIG. 9, at Step S142, the selection receiving unit 51b2 determines whether or not the process has been completed on all the selected control apparatuses. When the selection receiving unit 51b2 determines that the process has not yet been completed on all the selected control apparatuses (NO), the unit 51b2 advances the process to Step S120. When the selection receiving unit 51b2 determines that the process has been completed on all the selected control apparatuses (YES), the process is ended.

As described above, the system design supporting device 5 can create the first backup project data 54d1, the second backup project data 54d2, or the third backup project data 54d3, on the basis of the first profile data 54a1, the second profile data 54a2, or the third profile data 54a3.

That is, the system design supporting device 5 does not need middleware for creating the first backup project data 54d1, the second backup project data 54d2, or the third backup project data 54d3. Therefore, even when middleware is not provided from a manufacturer of the first control apparatus 2, the second control apparatus 3, or the third control apparatus 4, the system design supporting device 5 can still create the first backup project data 54d1, the second backup project data 54d2, or the third backup project data 54d3.

The first profile data 54a1, the second profile data 54a2, and the third profile data 54a3 have been created for the purpose of creating the first project data 54b1, the second project data 54b2, and the third project data 54b3. Accordingly, the system design supporting device 5 can minimize the man-hours required for creating the first backup project data 54d1, the second backup project data 54d2, or the third backup project data 54d3.

In a case where an additional control apparatus is newly installed in the system 1, the system design supporting device 5 can create backup project data for this new control apparatus on the basis of profile data created for the purpose of creating project data of the new control apparatus. Consequently, in the case where an additional control apparatus is newly installed in the system 1, the system design supporting device 5 can minimize the man-hours required for creating the backup project data.

In a case where a plurality of control apparatuses are selected on the system configuration diagram 54c, the system design supporting device 5 can create a plurality of pieces of backup project data for the selected control apparatuses. Therefore, the system design supporting device 5 can provide a collective backup process on a plurality of control apparatuses to a user, and can improve convenience for the user.

The system design supporting device 5 checks the details in the item of “version” within the profile data corresponding to a selected control apparatus, against the version of the selected control apparatus, and when the details in the item of “version” within the profile data corresponding to the selected control apparatus do not correspond with the version of the selected control apparatus, then the system design supporting device 5 can obtain the profile data which corresponds with the version of the selected control apparatus, from the location shown by the details in the item of “profile link information”.

When the details in the item of “version” within the profile data corresponding to the selected control apparatus do not match with the version of the selected control apparatus, there is a possibility that the data is not properly backed up. The system design supporting device 5 obtains the latest profile data that corresponds with the version of the selected control apparatus, thereby making it possible to perform the backup process more properly on the basis of the obtained latest profile data corresponding to the selected control apparatus.

When the version of the backup project data does not match with the version of the programming-tool program, the system design supporting device 5 can obtain the programming-tool program which corresponds with the version of the backup project data, from the location shown by the details in the item of “programming-tool link information”.

When the version within the backup project data does not match with the version of the programming-tool program, there is a possibility that the backup project data cannot be properly browsed or edited. The system design supporting device 5 obtains the latest programming-tool program that corresponds with the version of the backup project data, thereby making it possible to properly browse or edit the backup project data.

When the user information within the first profile data 54a1, the second profile 54a2, or the third profile data 54a3 matches with the user information 51b7d within the security information group 51b7, the system design supporting device 5 creates the backup project data. On the other hand, when the user information within the first profile data 54a1, the second profile 54a2, or the third profile data 54a3 does not match with the user information 51b7d within the security information group 51b7, the system design supporting device 5 does not create the backup project data.

Due to this operation, the system design supporting device 5 can permit only an authorized user to make the backup, while prohibiting an unauthorized user from making the backup. The first backup project data 54d1, the second backup project data 54d2, and the third backup project data 54d3 are important technical assets which include know-how to drive the industrial machine. The system design supporting device 5 can prevent the improper use of the technical assets by prohibiting a user, who is not permitted to make the backup, from making the backing-up.

When the first security flag 51b7a, the second security flag 51b7b, or the third security flag 51b7c represents that the first backup project data 54d1, the second backup project data 54d2, or the third backup project data 54d3 is to be partially or entirely encrypted, then the system design supporting device 5 can partially or entirely encrypt the first backup project data 54d1, the second backup project data 54d2, or the third backup project data 54d3.

The first backup parameter portion 54d1b, the second backup parameter portion 54d2b, and the third backup parameter portion 54d3b are important technical assets which include know-how to drive the industrial machine. When the first security flag 51b7a, the second security flag 51b7b, or the third security flag 51b7c is set to “1”, the system design supporting device 5 encrypts the first backup parameter portion 54d1b, the second backup parameter portion 54d2b, or the third backup parameter portion 54d3b, thereby making it possible to prevent the improper use of the technical assets.

The configurations shown in the above embodiment are only examples of the content of the present invention. The configurations can be combined with other publicly known techniques, or can be partially omitted or modified without departing from the scope of the present invention.

### REFERENCE SIGNS LIST

1 system; 2 first control apparatus; 3 second control apparatus; 4 third control apparatus; 5 system design supporting device; 6 server; 51 CPU; 51a programming-tool unit group; 51b backup processing unit; 51b1 system-configuration-diagram creation unit; 51b2 selection receiving unit; 51b3 project-data confirmation unit; 51b4 message creation unit; 51b5 communication packet transmission-reception unit; 51b6 backup unit; 51b7 security information group; 51b7a first security flag; 51b7b second security flag; 51b7c third security flag; 51b7d user information; 54 storage unit; 54a profile data group; 54a1 first profile data; 54a1a identification information; 54a1a1 project data information; 54a1a2 URL information; 54a1b communication information; 54a1b1 communication protocol information; 54a1c control information; 54a1d security information; 54a2 second profile data; 54a3 third profile data; 54b project data group; 54b1 first project data; 54b2 second project data; 54b3 third project data; 54c system configuration diagram; 54d backup project data group; 54d1 first backup project data; 54d2 second backup project data; 54d3 third backup project data.

1: A system design supporting device comprising:
a storage unit to store therein profile data including project data information in which a configuration of project data of a control apparatus is described, network identification information in which a communication path used to communicate with the control apparatus is described, and communication protocol information;
a system-configuration-diagram creation unit to create a system configuration diagram representing a connection configuration of the control apparatus on the basis of the network identification information within the profile data;
a selection receiving unit to display the system configuration diagram, and to receive a selection of the control apparatus on the system configuration diagram; and
a save unit to acquire project data that corresponds to the selected control apparatus, and to save the acquired project data.

2: The system design supporting device according to claim 1, wherein when two or more control apparatuses of the control apparatuses are selected on the system configuration diagram, the system design supporting device communicates with the selected control apparatuses to plural pieces of the project data.

3: The system design supporting device according to claim 1, wherein
the profile data further includes an item of version of a corresponding one of the control apparatuses, and an item of profile link information that indicates a location of a latest version or a previous version of the profile data, and
the system design supporting device further comprises a project-data confirmation unit to check details in the item of version within the profile data that corresponds to the selected control apparatus, against a version of the selected control apparatus, and to acquire the profile data which corresponds with a version of the selected control apparatus, from a location shown by details in the item of profile link information when the details in the item of version within the profile data that corresponds to the selected control apparatus do not match with the version of the selected control apparatus.

4: The system design supporting device according to claim 1, wherein
the profile data further includes an item of programming-tool link information that indicates a location of a latest version of a programming-tool program for creating the project data, or a location of a version previous to the latest version, and
the system design supporting device further comprises a programming-tool confirmation unit to check a version of the saved project data against a version of the programming-tool program, and to acquire the programming-tool program which corresponds with a version of the saved project data, from a location shown by details in the item of programming-tool link information when the version of the saved project data does not match with the version of the programming-tool program.

5: The system design supporting device according to claim 1, wherein
the profile data further includes an item of user information that indicates a user who has created the profile data,
the system design supporting device has second user information that indicates a user who is permitted to save the project data, and
when the user information matches with the second user information, the system design supporting device saves the project data, and when the user information does not match with the second user information, the system design supporting device does not save the project data.

6: The system design supporting device according to claim 1, comprising a plurality of security flags, each of which indicates whether or not the project data is partially or entirely encrypted, wherein
when the security flag indicates that the project data is to be partially or entirely encrypted, the system design supporting device partially or entirely encrypts the project data.

7: A system design supporting method that is executed by a device including a storage unit to store therein profile data including project data information in which a configuration of project data of a control apparatus is described, network identification information in which a communication path used to communicate with the control apparatus is described, and communication protocol information, the system design supporting method comprising:
a system-configuration-diagram creating step of creating a system configuration diagram that illustrates a connection configuration of the control apparatus on the basis of the network identification information within the profile data;
a selection receiving step of displaying the system configuration diagram, and receiving a selection of the control apparatus on the system configuration diagram; and
a saving step of acquiring project data that corresponds to the selected control apparatus, and saving the acquired project data.

8: A system design supporting program storage medium having a system design supporting program stored therein, the program being executed by a device including a storage unit to store therein profile data including project data information in which a configuration of project data of a control apparatus is described, network identification information in which a communication path used to communicate with the control apparatus, and communication protocol information, the system design supporting program comprising:
a system-configuration-diagram creating step of creating a system configuration diagram that illustrates a connection configuration of the control apparatus on the basis of the network identification information within the profile data;
a selection receiving step of displaying the system configuration diagram, and receiving a selection of the control apparatus on the system configuration diagram; and
a saving step of obtaining project data that corresponds to the selected control apparatus, and saving the obtained project data.
